(19) United States
(12) Patent Application Publication
(10) Pub. No.: US 2014/0049515 A1
(43) Pub. Date: Feb. 20, 2014

(54) VIRTUAL MOUSE AND OPERATING METHOD THEREOF

(71) Applicant: ASUSTeK COMPUTER INC., Taipei (TW)

(72) Inventors: Hsiao-Kai LI, Taipei (TW); Ping-Cheng HSIEH, Taipei (TW); Kuo-Chung CHIU, Taipei (TW)

(73) Assignee: ASUSTeK COMPUTER INC., Taipei (TW)

(21) Appl. No.: 13/958,018

(22) Filed: Aug. 2, 2013

(30) Foreign Application Priority Data
Aug. 20, 2012 (TW) 101130096

(51) Int. Cl. G06F 3/041

(52) U.S. Cl. CPC G06F 3/0416
USPC 345/175; 345/173

(57) ABSTRACT

A virtual mouse is provided. The virtual mouse is coupled to an electronic device. The virtual mouse includes a touch unit, a detecting unit and a processing unit. The touch unit receives at least one touch event and outputs an input signal according to each of the at least one touch event, respectively. The detecting unit detects the at least one touch event to obtain a first parameter corresponding to each of the at least one touch event, respectively. The processing unit compares the first parameter corresponding to each of the at least one touch event with a first default value, respectively, to obtain a first comparing result corresponding to each of the at least one touch event. Whether the processing unit transmits the input signal to the electronic device is determined according to each of the first comparing result.

### CROSS REFERENCE TO RELATED APPLICATIONS

This application claims the priority benefit of Taiwan application serial No. 101130096, filed on Aug. 20, 2012. The entirety of the above-mentioned patent application is hereby incorporated by reference herein and made a part of specification.

### BACKGROUND OF THE INVENTION

1. Field of Invention

The disclosure relates to a virtual mouse and an operating method thereof.

2. Description of Related Art

A mouse is usually used as an input device and widely applied to an electronic device, such as a personal computer or a notebook computer. A user operates the electronic device by a mouse instead of a keyboard, which can avoid complicated commands and make the operation of the electronic device simplified, intuitive and efficient.

However, if a user brings a portable notebook computer with a physical mouse additionally, he or she may feel heavy and inconvenient. Thus, a notebook computer usually includes a touchpad to provide a function of a mouse. Since a touchpad is usually disposed at a frame of a keyboard of a notebook computer, when the user types or operates the notebook, he or she may touch the touchpad by mistake. Consequently, the size of the touchpad should be limited to a small size to reduce a probability of touch by mistake.

### BRIEF SUMMARY OF THE INVENTION

A virtual mouse applied to an electronic device is provided. The virtual mouse includes a touch unit, a detecting unit and a processing unit. The touch unit receives at least a touch event and outputs an input signal according to each of the touch events, respectively. The detecting unit detects each of the touch events to obtain a first parameter corresponding to each of the touch events, respectively. The processing unit compares the first parameter corresponding to each of the touch events with a first default value, respectively, to obtain a first comparing result corresponding to each of the touch events, respectively, and whether the processing unit transmits the input signal to the electronic device is determined according to each of the first comparing results, respectively.

An operating method of a virtual mouse is also provided. The virtual mouse is coupled to an electronic device. The operating method includes following steps: providing at least a touch event to the virtual mouse; outputting an input signal by the virtual mouse according to each of the touch events, respectively; detecting each of the touch events by the virtual mouse to obtain a first parameter corresponding to each of the touch events, respectively; comparing the first parameter corresponding to each of the touch events with a first default value by the virtual mouse to obtain a first comparing result corresponding to each of the touch events, respectively; and transmitting or not transmitting the input signal to the electronic device by the virtual mouse according to each of the first comparing results, respectively.

These and other features, aspects and advantages of the present disclosure will become better understood with regard to the following description, appended claims, and accompanying drawings.

### BRIEF DESCRIPTION OF THE DRAWINGS

FIG. 1A is a schematic diagram showing a virtual mouse in a first embodiment;

FIG. 1B is a block diagram showing a virtual mouse in a first embodiment;

FIG. 2A to FIG. 2D are schematic diagrams showing a touch event in different embodiments;

FIG. 3A is a flow chart showing an operating method of a virtual mouse in a second embodiment;

FIG. 3B is a flow chart showing an operating method of a virtual mouse in a third embodiment;

FIG. 3C is a flow chart showing an operating method of a virtual mouse in a fourth embodiment; and

FIG. 4 is a schematic diagram showing actuation of a touch event.

### DETAILED DESCRIPTION OF THE INVENTION

A virtual mouse and an operating method thereof are illustrated with relating figures, and the same symbols denote the same components.

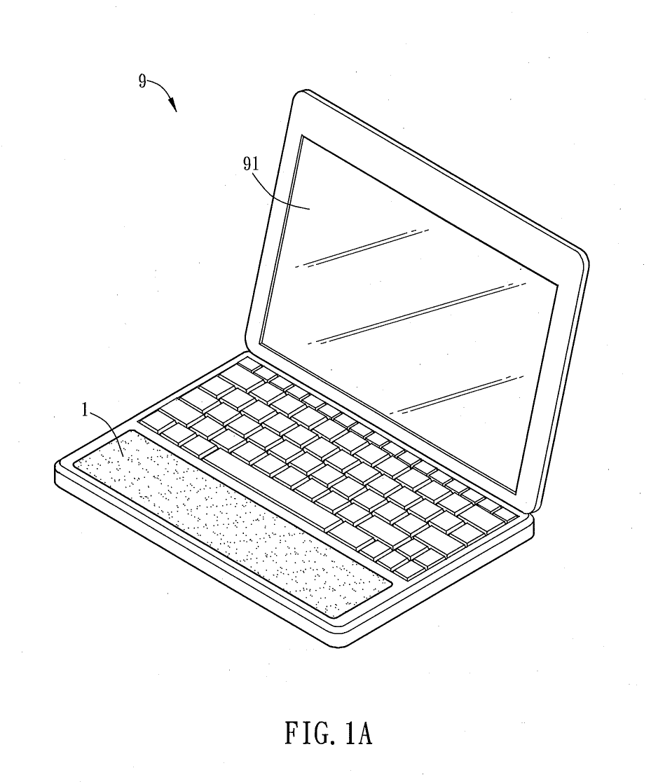

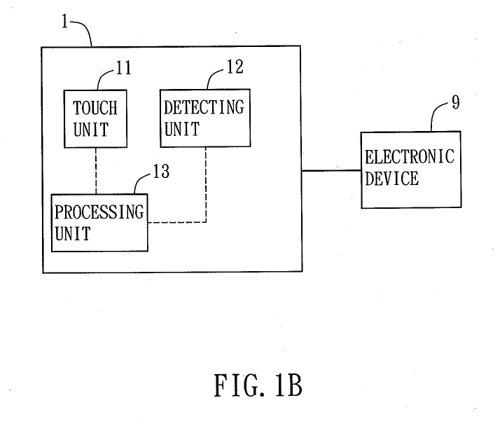

FIG. 1A is a schematic diagram showing a virtual mouse in a first embodiment. FIG. 1B is a block diagram showing a virtual mouse in a first embodiment. The virtual mouse 1 is coupled to an electronic device 9, such as a personal computer or a notebook computer. The virtual mouse 1 includes a touch unit 11, a detecting unit 12 and a processing unit 13.

The touch unit 11 may be a capacitive multi-point touch panel which receives at least one touch event and outputs an input signal according to each of the touch events. For example, when the touch unit 11 receives a touch event, it outputs an input signal correspondingly. When the touch unit 11 receives two touch events, it outputs an input signal corresponding to one touch event, and outputs another input signal corresponding to the other touch event, and the rest can be deduced by analogy. The touch unit 11 is a capacitive multi-point touch panel as an example hereinafter.

The detecting unit 12, such as an optical sensing element or a pressure sensing element, detects the touch event to obtain a first parameter corresponding to the touch event. The first parameter includes the area, the shape, the pressure or the duration time of the touch event. When multiple touch events are detected, a second parameter corresponding to the multiple touch events is further obtained. The second parameter may include a distance between the touch events or the number of the touch events.

The processing unit 13, such as a system on chip (SOC) which has a calculating function, compares the first parameter with a first default value to obtain a first comparing result. The second parameter is compared with a second default value to obtain a second comparing result, and then the processing unit 13 transmits or does not transmit the input signals to the electronic device according to the comparing results, respectively.

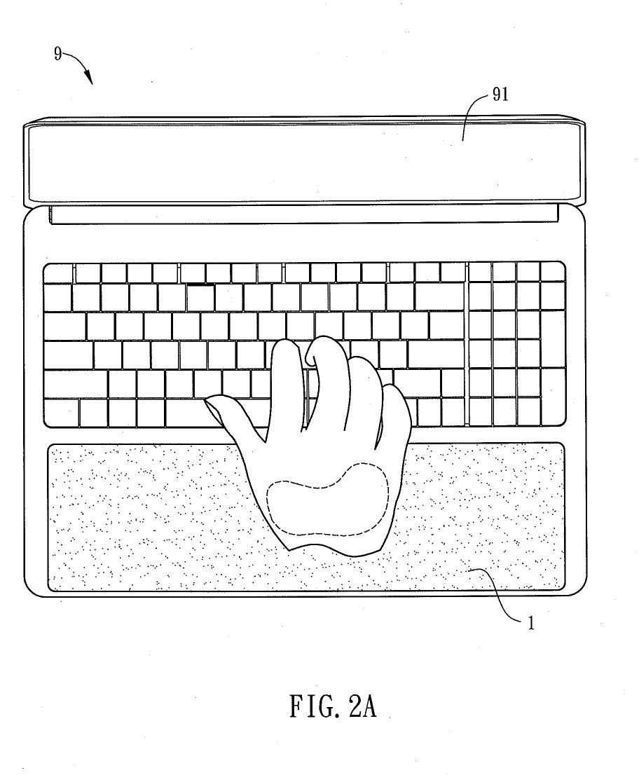

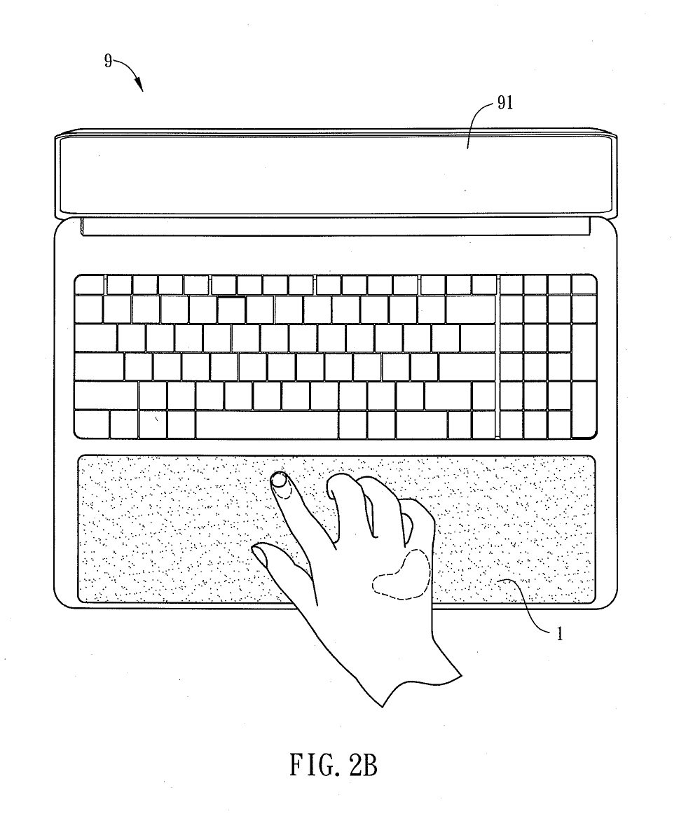

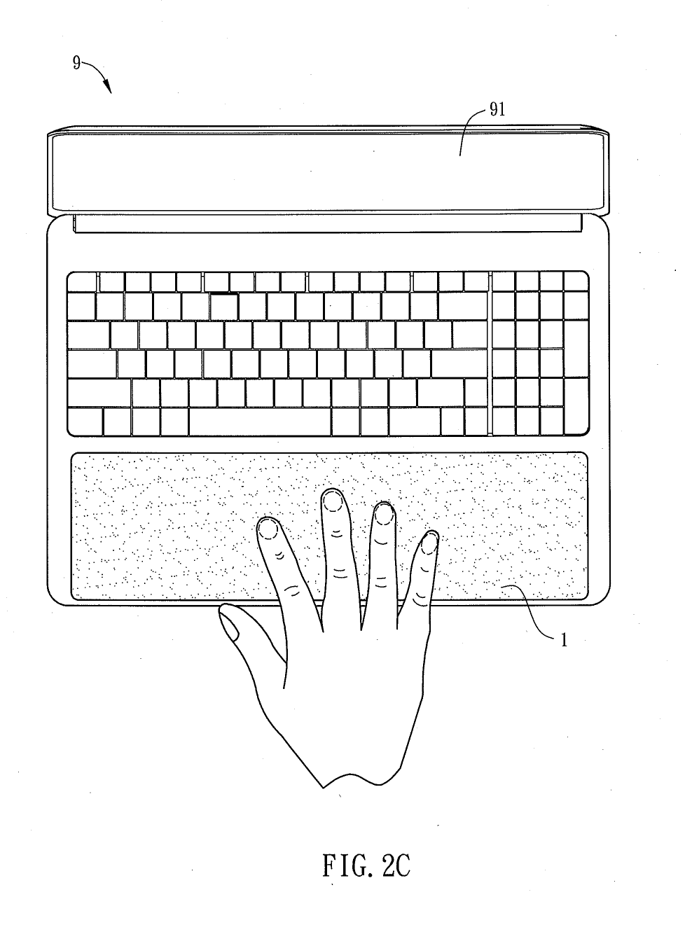

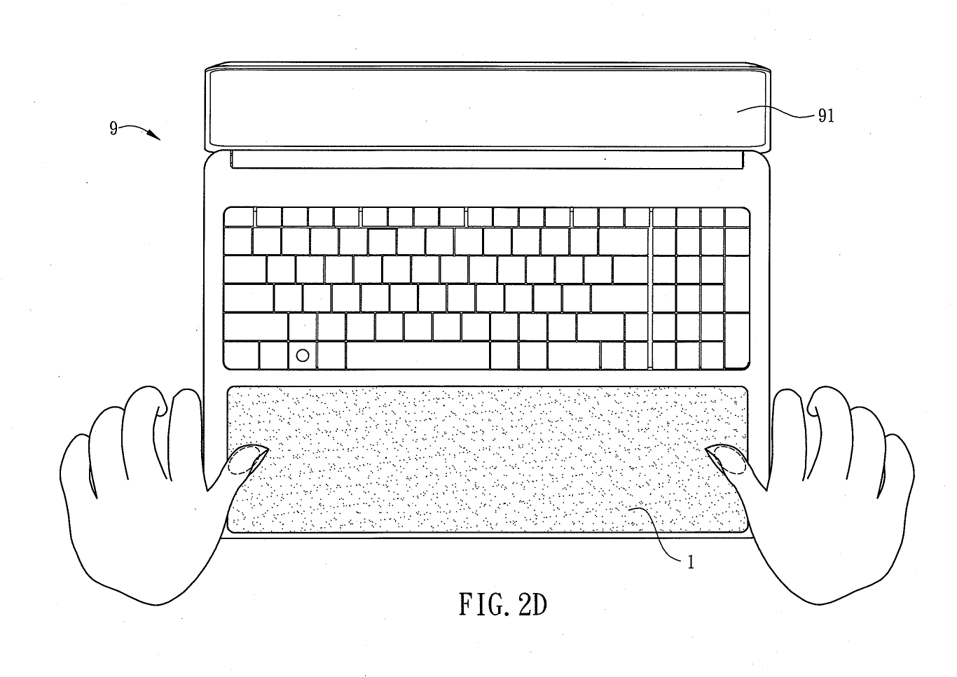

FIG. 2A to 2D are schematic diagrams showing a touch event in different embodiments. Please refer to FIG. 2A, a part of a palm contacts the touch unit 11 and provides a touch event to the touch unit 11, as shown in a dotted line in FIG. 2A. In the embodiment, the first parameter is the area of the touch event, and the area detected by the detecting unit 12 is the area of a palm. The first default value may be the area of a thumb tip. The processing unit 13 compares the first parameter and the first default value to obtain the first comparing result which is that the first parameter is larger than the first default value. Thus, the processing unit 13 does not transmit the corresponding input signal to the electronic device 9.

When the user uses the virtual mouse 1, he or she usually operates by fingertips. If a contact area of the touch event is larger than the area of a fingertip, such as the area of a palm, a face, a forehead or a chin, the first parameter corresponding to the contact area of the touch event is larger than the first default value. Thus, the processing unit 13 determines the touch event is a touch by mistake, and does not transmit the corresponding input signal to the electronic device 9. On the contrary, when the first parameter corresponding to the area of the touch event is smaller than or equals to the first default value, the processing unit 13 determines the touch event is not a touch event by mistake, and then transmits the corresponding input signal to the electronic device 9.

In different embodiments, the first default value corresponding to the contact area of the touch event may be different, such as an average value of the area of thumb tips of different users, which is not limited herein.

Please refer to FIG. 2A, the difference from the previous embodiment is that the first parameter is the pressure of the touch event. The detecting unit 12 detects that the pressure is generated by a palm. The first default value may be a pressure generated by a thumb tip. The processing unit 13 compares the first parameter with the first default value to obtain the first comparing result which is that the first parameter is larger than the first default value. Thus the processing unit 13 does not transmit the corresponding input signal to the electronic device 9.

Moreover, the first parameter may also be the shape of the touch event. The shape detected by the detecting unit 12 is formed by a part of a palm contacting the touch unit 11, and the first default value is the shape of a contact area (which may be in an ellipse shape) of a thumb tip contacting with the touch unit 11. The processing unit 13 compares the first parameter with the first default value to obtain the first comparing result that the difference between the first parameter and the first default value exceeds a threshold. Thus the processing unit 13 does not transmit the corresponding input signal to the electronic device 9.

In different embodiments, the first default value corresponding to the shape of the touch event is different. The shape correspondingly may be an ellipse, a circle or an irregular shape, which is not limited herein. Thus, the shape and the size relating to the first default value are not limited herein.

Furthermore, the detecting unit 12 may also detect the duration time of the touch event. When the first parameter corresponding to the duration time of the touch event is larger than the first default value (such as 3 seconds), the processing unit 13 determines that the touch event is a touch event by mistake, and it does not transmit the corresponding input signal to the electronic device 9. On the contrary, when the first parameter corresponding to the duration time of the touch event is smaller than or equals to the first default value, the processing unit 13 determines the touch event is not a touch event by mistake, and transmits the corresponding input signal to the electronic device 9.

Please refer to FIG. 2B, in the embodiment, two touch events are received. One touch event is provided by a forefinger tip, and the other is provided by a part of a palm, as shown in a dotted line in FIG. 2B. The first parameter detected by the detecting unit 12 is the area of the touch event as an example. The area of the touch event provided by the forefinger tip is smaller than the first default value. Thus the input signal corresponding to the touch event provided by the forefinger tip is transmitted to the electronic device 9 by the processing unit 13. The area of the touch event provided by a part of the palm is larger than the first default value. Thus the input signal corresponding to the touch event provided by a part of the palm is not transmitted to the electronic device 9 by the processing unit 13.

In other words, when the virtual mouse 1 receives multiple touch events, the processing unit 13 determines whether each of the touch events is a touch event by mistake, respectively. If the determining result is a touch event by mistake, the processing unit 13 does not transmit the corresponding input signal to the electronic device 9. On the contrary, if the determining result is not a touch event by mistake, the corresponding input signal is transmitted to the electronic device 9.

Please refer to FIG. 2C, in the embodiment, four fingertips provide four touch events to the touch unit 11, as shown in a dotted line in FIG. 2C. The detecting unit 12 detects the area of each of the touch events, and also detects the number (that is the second parameter) of the touch event. Although each of the area of the touch events is smaller than the first default value, the number of the touch events is larger than the second default value (such as three). Thus the processing unit 13 does not transmit the input signals to the electronic device 9.

Specifically, when the user operates the virtual mouse 1, he or she usually would not use four fingers to operate the virtual mouse 1. Therefore when the detecting unit 12 detects the number of the touch events is more than three, the processing unit 13 determines the touch events are touch events by mistake and does not transmit the input signal to the electronic device 9. On the contrary, the processing unit 13 transmits the input signal corresponding to the touch events which are not touch events by mistake to the electronic device 9 according to the first comparing result. In different embodiments, the second default value may be different, which is not limited herein.

Please refer to FIG. 2D, in the embodiment. User's fingers of right hand and fingers of left hand contact the oppositive sides of the virtual mouse 1 to provide two touch events to the touch unit 11, respectively, as shown in a dotted line in FIG. 2D. The detecting unit 12 detects the area of each of the touch events, and also detects a distance (which is the second parameter) between occurring positions of one touch event and the other touch event. Although each of the first parameters corresponding to the touch events is smaller than the first default value, the second parameter is larger than the second default value (such as 10 cm). Thus the processing unit 13 determines the two touch events are touch events by mistake and does not transmit the input signals to the electronic device 9.

Moreover, the processing unit 13 receives an enabling or disabling signal from the electronic device 9, and enables or disables the touch unit 11 accordingly. When the user uses the keyboard, the electronic device 9 sends out a disabling signal to the virtual mouse 1, and the processing unit 13 disables the touch unit 11. When the user stops using the keyboard for a period of time (such as one second), the electronic device 9 sends out an enabling signal to the virtual mouse 1, and the processing unit 13 enables the touch unit 11 again. Thus, when the user types the keyboard, the cursor would not move unexpectedly due to a touch event by mistake.

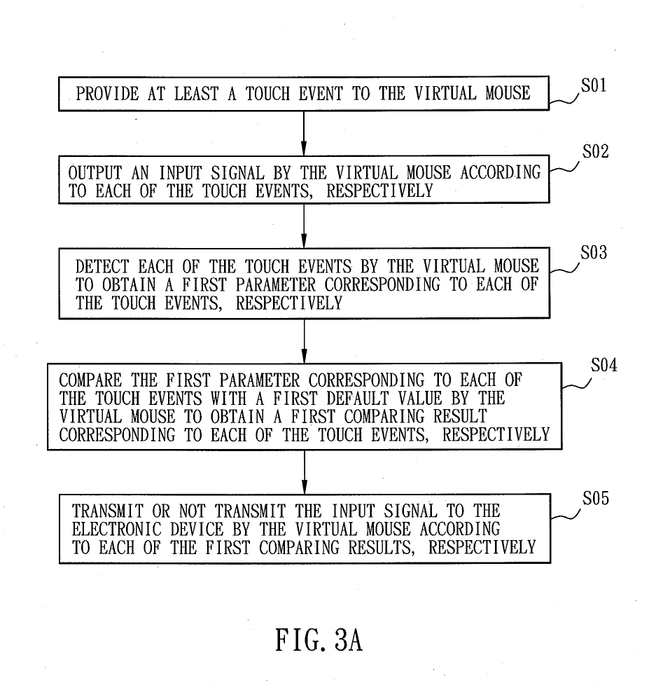

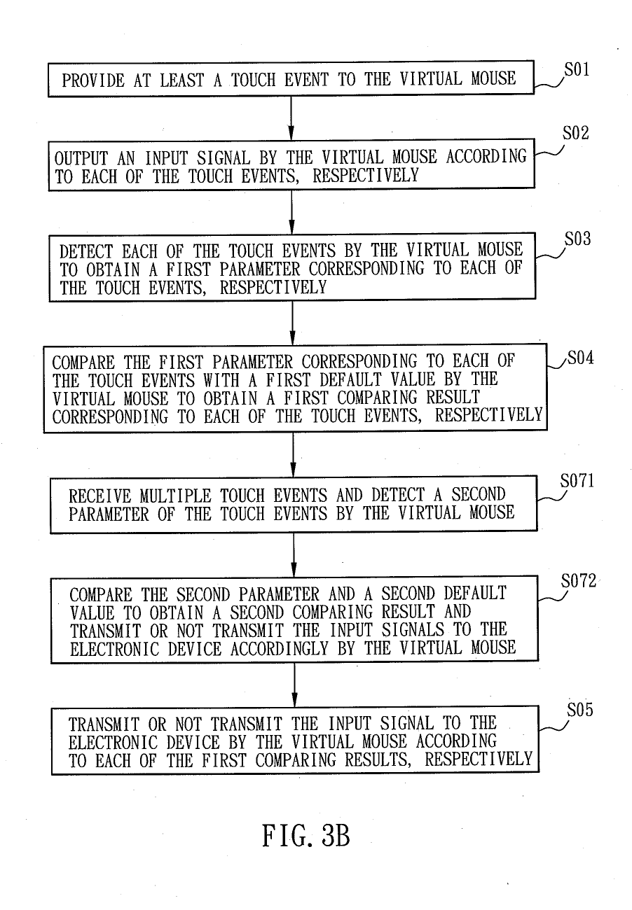

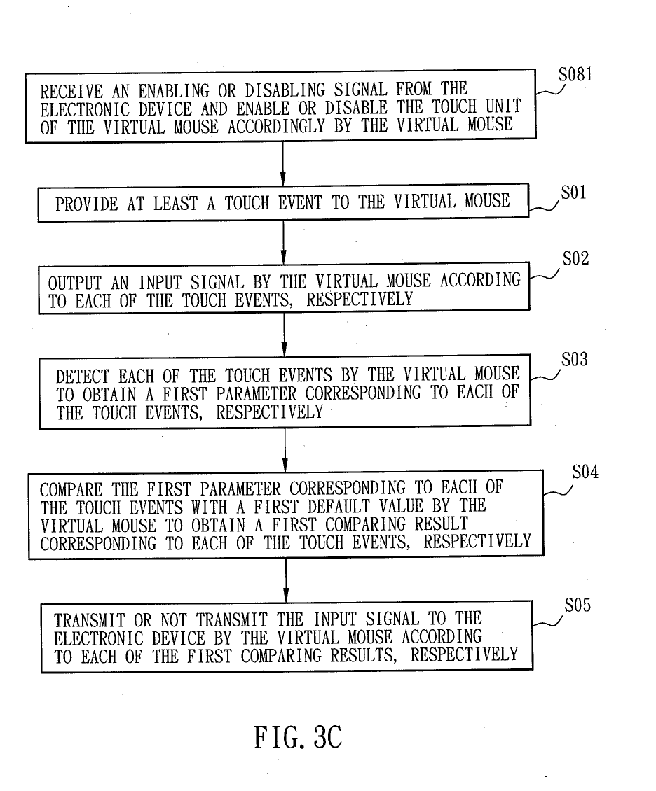

FIG. 3A is a flow chart showing an operating method of a virtual mouse in a second embodiment. In the embodiment, the operating method is applied to a virtual mouse, and please refer to FIG. 1A and FIG. 1B at the same time.

The virtual mouse 1 is coupled to an electronic device 9. The components in the electronic device 9 are illustrated in previous embodiments, which are omitted herein.

In step S01, at least one touch event is provided to the virtual mouse.

In step S02, the virtual mouse outputs an input signal according to each of the touch events, respectively.

In step S03, the virtual mouse detects each of the touch events to obtain a first parameter corresponding to each of the touch events, respectively, and the first parameter includes the area, the shape, the pressure or the duration time of the touch event.

In step S04, the virtual mouse compares the first parameter corresponding to each of the touch events with a first default value to obtain a first comparing result corresponding to each of the touch events, respectively.

In step S05, whether the virtual mouse transmits transmit the input signal to the electronic device is determined according to each of the first comparing results, respectively.

How the input signal is transmitted or not transmitted to the electronic device 9 according to a comparing result of the first parameter and the first default value is illustrated in the previous embodiments, please refer to FIG. 2A and FIG. 2B, which is omitted herein.

In other words, when the virtual mouse 1 receives multiple touch events at the same time, the processing unit 13 determines whether each of the touch events is a touch event by mistake or not, respectively. If yes, the processing unit 13 does not transmit the corresponding input signal to the electronic device 9. If no, the corresponding input signal is transmitted to the electronic device 9.

FIG. 3B is a flow chart showing an operating method of a virtual mouse in a third embodiment. The operating method in the embodiment approximately is similar with that in FIG. 3A, and the difference is illustrated hereinafter.

In step S071, the virtual mouse detects the number of the touch events, and if the number of the touch events is more than one, the virtual mouse detects a second parameter of the touch events. The second parameter may be a distance between occurring positions of two touch events or the number of the touch events.

In step S072, the virtual mouse compares the second parameter and a second default value to obtain a second comparing result, and then whether the input signals are transmitted to the electronic device is determined according to the first comparing result and the second comparing result.

Please refer to FIG. 2C and FIG. 2D, the features in the embodiment which are the same as those in previous embodiments are omitted herein.

Furthermore, when one of the touch events is sliding inwards from one edge of the virtual mouse, the virtual mouse transmits the input signal corresponding to the touch event to the electronic device. In other words, the virtual mouse determines that the touch event is not a touch event by mistake, and it transmits the input signal corresponding to the touch event to the electronic device. When the electronic device 9 receives an output signal corresponding to the touch event, it activates correspondingly. For example, in the embodiment, the electronic device 9 displays an object 8 at a display unit 91 according to the output signal corresponding to the touch event. The object 8 may be an application program which is used frequently, such as an application, a file, date or time.

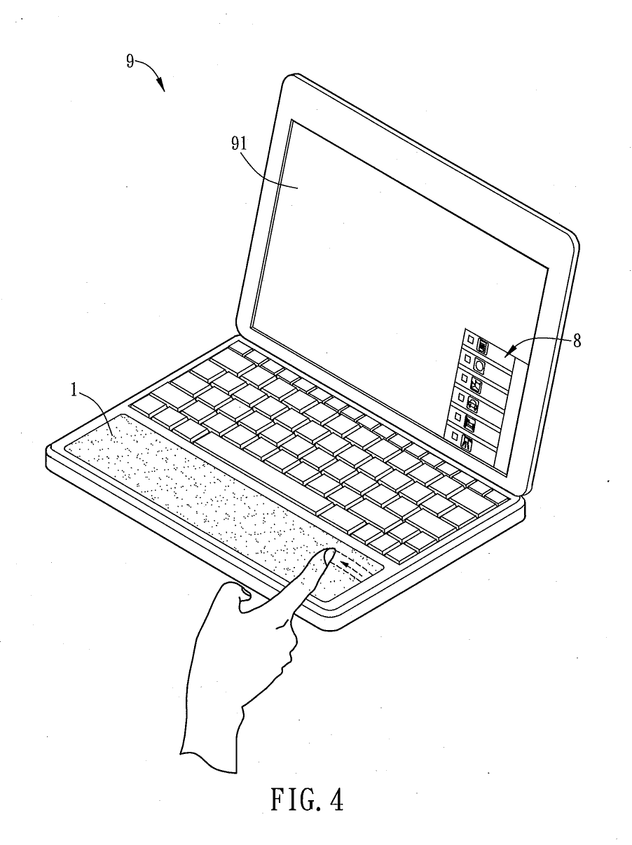

FIG. 4 is a schematic diagram showing actuation of a touch event. When the electronic device 9 receives a calling signal, a processor (not shown) of the electronic device 9 at least calls an object 8 stored in a memory unit (not shown) in the electronic device 9, and the object 8 is displayed at the display unit 91. The object 8 may be displayed at one side of the display unit 91 corresponding to the edge of the virtual mouse 1.

FIG. 3C is a flow chart showing an operating method of a virtual mouse in a fourth embodiment. The operating method in the embodiment is similar with that in FIG. 3A, and the difference is illustrated hereinafter.

In step S081, the virtual mouse receives an enabling or disabling signal from the electronic device and enables or disables the touch unit of the virtual mouse accordingly. The relating features in the embodiment are illustrated in the previous embodiments, which are omitted herein.

In sum, the virtual mouse and the operating method thereof determines whether a touch event received by the touch unit is a touch event by mistake or not via the detecting unit and the processing unit, which can reduce a probability of a touch event by mistake on the touch unit. Furthermore, the size of the touch unit is not limited, and the user can operate more intuitively and conveniently via a large-size touch unit.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A virtual mouse coupled to an electronic device, the virtual mouse comprising:
a touch unit receiving at least one touch event and outputting an input signal according to each of the touch events, respectively;
a detecting unit detecting each of the touch events to obtain a first parameter corresponding to each of the touch events, respectively; and
a processing unit comparing the first parameter corresponding to each of the touch events with a first default value, respectively, to obtain a first comparing result corresponding to each of the touch events, respectively,
wherein whether the processing unit transmits the input signal to the electronic device is determined according to each of the first comparing results, respectively.

2. The virtual mouse according to claim 1, wherein when multiple the touch events are received, the detecting unit detects a second parameter corresponding to the touch events, respectively.

3. The virtual mouse according to claim 2, wherein the processing unit compares the second parameter with a second default value to obtain a second comparing result, and whether the processing unit transmits the input signals to the electronic device is determined according to the first comparing result and the second comparing result, respectively.

4. The virtual mouse according to claim 2, wherein the second parameter is a distance between occurring positions of the touch events or the number of the touch events.

5. The virtual mouse according to claim 1, wherein the first parameter includes the area, the shape, the pressure or the duration time of the touch event.

6. The virtual mouse according to claim 1, wherein the detecting unit is one or a combination of an optical sensing element and a pressure sensing element.

7. The virtual mouse according to claim 1, wherein the processing unit receives an enabling signal or a disabling signal from the electronic device to enable or disable the touch unit accordingly.

8. An operating method of virtual mouse, wherein the virtual mouse is coupled to an electronic device, the operating method comprising following steps:
providing at least one touch event to the virtual mouse;
outputting an input signal by the virtual mouse according to each of the touch events, respectively;
detecting each of the touch events by the virtual mouse to obtain a first parameter corresponding to each of the touch events, respectively;
comparing the first parameter corresponding to each of the touch events with a first default value by the virtual mouse to obtain a first comparing result corresponding to each of the touch events, respectively; and
transmitting or not transmitting the input signal to the electronic device by the virtual mouse according to each of the first comparing results, respectively.

9. The operating method according to claim 8, wherein the operating method further includes: detecting the number of the touch events by the virtual mouse, wherein if multiple touch events are received, the virtual mouse detects a second parameter of the touch events, respectively.

10. The operating method according to claim 9, wherein the operating method further includes: comparing the second parameter with a second default value by the virtual mouse to obtain a second comparing result and transmit or not transmit the input signals to the electronic device according to the first comparing result and the second comparing result, respectively.

11. The operating method according to claim 9, wherein the second parameter is a distance between occurring positions of the touch events or the number of the touch events.

12. The operating method according to claim 8, wherein the operating method further includes: receiving an enabling signal or a disabling signal from the electronic device by the virtual mouse to enable or disable the touch unit accordingly.

13. The operating method according to claim 8, wherein when one of the touch events is sliding inwards from one edge of the virtual mouse, the virtual mouse transmits the input signal corresponding to the touch event to the electronic device.

14. The operating method according to claim 8, wherein the first parameter includes the area, the shape, the pressure or the duration time of the touch event.
